(19) United States
(12) Patent Application Publication
(10) Pub. No.: US 2005/0249496 A1
(43) Pub. Date: Nov. 10, 2005

(54) Optical cross-connector of multi-granular architecture

(75) Inventors: Ludovic Noirie, Nozay (FR); Denis Penninckx, Nozay (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/610,711

(22) Filed: Jul. 2, 2003

(30) Foreign Application Priority Data
Jul. 4, 2002 (FR) 02 08 376

(51) Int. Cl. H04J 14/00

(52) U.S. Cl. 398/54

(57) ABSTRACT

The present invention relates to an optical cross-connector (1000) of multi-granular architecture comprising a first switching stage (100) for switching composite digital optical signals, the switching stage comprising a first optical switching matrix (1 to 4), wavelength band demultiplexing and multiplexer means (10, 20; 10′, 20′), a second switching stage (200) for switching digital optical signals and comprising a second switching matrix (5), wavelength demultiplexing and multiplexer means (61 to 64; 61′ to 64′), redirection outlet ports (11′ to 42′) of the first matrix being coupled to direction inlet ports of the second matrix. The optical first matrix comprises a series of independent optical switching sub-matrices (1 to 4) disposed in parallel. The number of redirection outlet ports (11′ to 42′) from the first matrix is greater than the number of wavelength demultiplexer means (61 to 64), and the cross-connector includes an optical concentrator (7) having more inlet ports (71 to 78) connected to said redirection outlet ports of the first matrix than outlet ports (71′ to 74′) connected to said wavelength demultiplexer means.

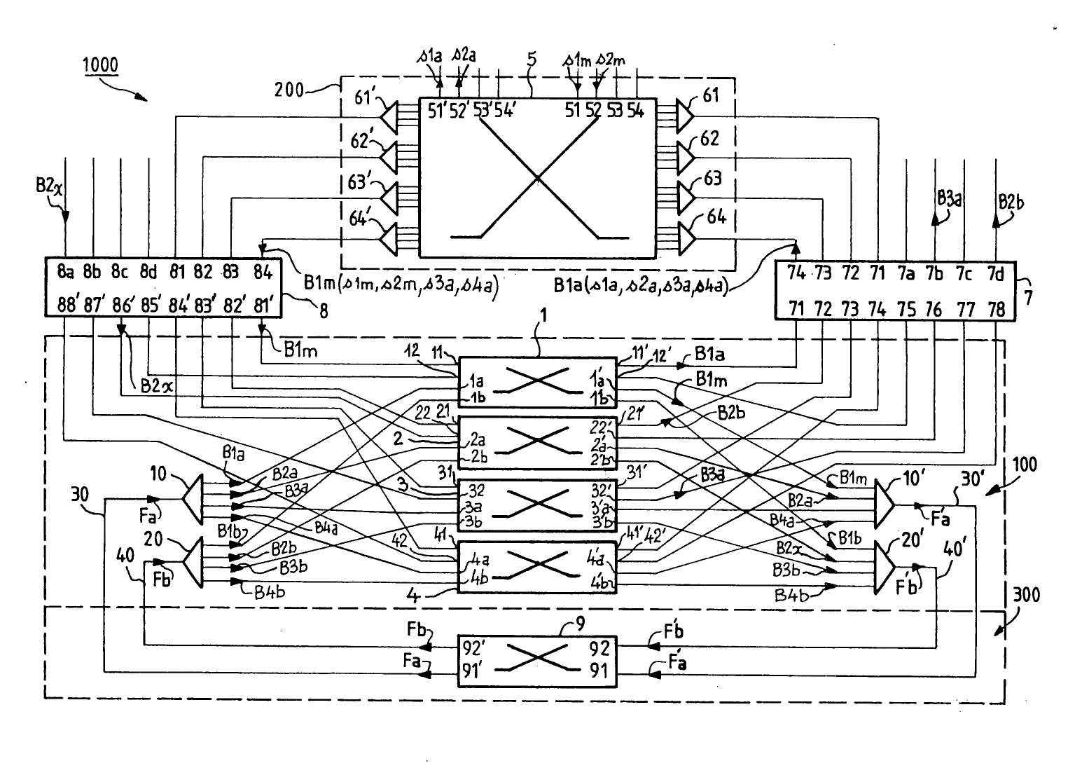

The present invention relates to an optical cross-connector of multi-granular architecture for use in a communications node of an optical telecommunications network.

Optical networks are intended to convey very large quantities of digital data traffic on continental and inter-continental scales, for example for multimedia applications on the Internet. At present optical technology makes it possible to provide data rates of the order of tera bits (10¹² bits) per second (Tb/s) on a single fiber, without reaching the theoretical upper limit which is much higher. This technology thus constitutes the future solution for high density information exchange, in particular for voice and video.

Known optical telecommunications networks use the principle of switching based on communications nodes provided with high speed cross-connectors for directing groups of optical signals carrying digital data, generally by amplitude modulation of optical carrier waves.

The document entitled “Multi-granularity optical cross-connect” by L. Noirie et al., Paper 9.2.4, European Conference on Optical Communication 2001, Munich, Germany, Sep. 3-7, 2001 discloses an optical cross-connector having three levels of granularity, i.e. capable of routing groups of data having a common destination by wavelength, by wavelength band, by an optical fiber.

That multi-granular approach enables the capacity of the transmission network to be increased while maintaining a reasonable level of complexity for switching.

Such a cross-connector has three optical switching stages, respectively for wavelengths, for wavelength bands, and for optical fibers. Each stage uses an optical switching matrix having the function of directing groups of digital optical signals by means respectively of a set of inlet ports and a set of outlet ports referred to as direction ports in that text.

In the embodiment described, additional outlet ports from the matrix dedicated to wavelength bands are interconnected with additional inlet ports of the matrices dedicated to wavelengths via wavelength demultiplexer means. Symmetrically, the additional outlet ports of the matrices dedicated to wavelengths are interconnected with additional inlet ports of the matrix dedicated to wavelength bands via wavelength multiplexer means. By means of these additional ports referred to in that text as redirection ports, data associated with wavelengths within each wavelength band can be rearranged dynamically or “groomed”.

However, in such a configuration, the wavelength band switching matrix has a very large total number of ports which increases its manufacturing costs and also the costs of its interfaces. In addition, that leads to high transmission losses which need to be compensated by amplifiers, thereby reducing the transmission distances possible for data in wavelength bands.

Document EP 1 193 995 describes a multi-granularity optical cross-connector comprising a single switching matrix for switching all levels of granularity simultaneously. Depending on requirements, i.e. on the traffic for switching, suitable numbers of ports of the single matrix are allocated respectively to a low level of granularity (wavelengths), to an intermediate level of granularity (wavelength bands), and finally to a high level of granularity (fibers). That prior art cross-connector comprises:
p1 inlet ports respectively receiving p1 wavelengths, p2 outlet ports, and first director means for directing the wavelengths received on said p1 inlet ports selectively to said p2 outlet ports; and/or
q1 inlet ports respectively receiving q1 wavelength bands;
q2 outlet ports and second director means suitable for directing the wavelength bands received on said q1 inlet ports selectively to said q2 outlet ports; and/or
r1 inlet ports respectively receiving r1 groups of bands, r2 outlet ports, and third director means suitable for directing groups of bands received on said r1 inlet ports selectively to said r2 outlet ports.

Those first, second, and third director means are constituted by a single switching matrix suitable for coupling any one of said p1+q1+r1 inlet ports to any one of said p2+q2+r2 outlet ports.

However, in that second configuration, the single switching matrix has a total number of ports which is still large.

An object of the present invention is to propose an optical cross-connector of complexity that is reduced even further, enabling wavelength bands to be redirected (dynamically) in optimal manner.

To this end, the invention provides an optical cross-connector of multi-granular architecture comprising:
a first switching stage for switching composite digital optical signals, each composite signal being made up of a plurality of digital optical signals in a given wavelength band, the stage comprising:
   a first optical switching matrix having direction inlet ports and direction outlet ports, and having redirection inlet ports and redirection outlet ports;
   a number p greater than or equal to 2 of wavelength band demultiplexer means, each being connected to a distinct one of said direction inlet ports; and
   p wavelength band multiplexer means, each connected to a distinct one of said direction outlet ports;
a second switching stage for switching digital optical signals, the stage comprising:
   a second switching matrix having direction inlet ports and direction outlet ports;
   a set of wavelength demultiplexer means, each of said means being connected to distinct direction inlet ports of the second matrix; and
   a set of wavelength multiplexer means, each of said means being connected to distinct ones of said direction outlet ports of said second matrix; said redirection outlet ports of the first matrix being coupled with said direction inlet ports of the second matrix via said set of wavelength demultiplexer means in order to obtain dynamic redirection of composite signals from the first stage to the second stage;

the cross-connector being characterized in that the first optical matrix is made up of a series of independent optical switching sub-matrices disposed in parallel;

and in that the number of redirection outlet ports from the first matrix is greater than the number of wavelength demultiplexer means, the cross-connector having an optical concentrator with more inlet ports connected to said redirection outlet ports of the first matrix than outlet ports connected to said wavelength demultiplexer means.

Using sub-matrices in accordance with the invention instead of a single matrix as in the prior art reduces the cost of the switching stage for the wavelength bands. The sub-matrices are also simpler to manufacture, and together these sub-matrices are less bulky than a single matrix and are therefore easier to integrate.

In addition, in this cross-connector configuration, in order to make the maximum amount of composite signal redirection possible, i.e. the maximum amount of wavelength band redirection possible, it is necessary to have more redirection ports than with a single matrix which directs wavelength bands without treating them specially. The redirection ports are suitably distributed amongst the various sub-matrices.

Nevertheless, statistically speaking, it can be shown that not all of the redirection outlet ports are in use simultaneously. This can be done by calculating the mean number of redirection ports used simultaneously and the maximum number of ports that can be used on the basis of knowledge concerning traffic fluctuations. These fluctuations depend on variations in the numbers of users connected to the cross-connector, variations in the numbers of connections, and variations in connection times per user. It can be deduced therefrom that the number of wavelength demultiplexer means liable to be simultaneously receiving wavelength bands can be less than the number of redirection outlet ports. This makes it possible to avoid excessive consumption of interfaces and overdimensioning, and thus to avoid making the second matrix too expensive. In addition, it is the optical concentrator of the invention which manages dynamic redirection of composite signals between the first stage and the second stage.

Advantageously, the set of wavelength multiplexer means may include at least one cyclical wavelength demultiplexer means, said means being preferably selected from optical interlacers and arrays of waveguides.

A cyclical wavelength demultiplexer means serves to demultiplex any wavelength band passing through the concentrator, and thus increase access to the second matrix for the wavelengths of each band.

The optical concentrator of the invention may also include at least one drop port for dropping composite signals intended specifically for a local network connected to said cross-connector.

In an advantageous embodiment, said p wavelength band demultiplexer means are provided with n outlet ports, where n is greater than or equal to 2, corresponding to the total number of wavelength bands processed in said cross-connector. And said series of sub-matrices comprises n sub-matrices, each being dedicated to a distinct wavelength band, comprising p inlet and outlet redirection ports together with p inlet and outlet direction ports.

In this particular embodiment, the set of wavelength demultiplexer means may include a number n less than n×p of cyclical wavelength demultiplexer means, said concentrator having n×p inlet ports and m outlet ports for dynamically redirecting composite signals from the first stage to the second stage.

In a preferred embodiment, the number of redirection inlet ports of the first matrix is greater than the number of wavelength multiplexer means, and the cross-connector includes an optical deconcentrator having more outlet ports connected to said redirection inlet ports of the first matrix than inlet ports connected to said wavelength multiplexer means in order to achieve dynamic redirection of composite signals from the second stage to the first stage.

In a manner similar to the optical concentrator, the deconcentrator serves to optimize dynamic redirection of composite signals from the second stage to the first stage.

The optical deconcentrator may also include at least one add port for adding composite signals into the traffic.

Preferably, the set of wavelength multiplexer means includes at least one cyclical wavelength multiplexer means preferably selected from optical interlacers and waveguide arrays.

A cyclical multiplexer means enables wavelengths to be multiplexed from any wavelength band, and thus makes it possible to increase the number of outlet ports from the second matrix that can be selected by the wavelengths.

In a configuration of the invention, said p wavelength band multiplexer means are provided with n inlet ports where n is greater than or equal to 2, and corresponds to the total number of wavelength bands processed in said cross-connector. Said series of sub-matrices comprises n sub-matrices, each being dedicated to a distinct wavelength band, each comprising p inlet and outlet redirection ports and p inlet and outlet direction ports.

In this configuration, the set of wavelength multiplexer means may include a number m′ less than n×p of cyclical wavelength multiplexer means, and said deconcentrator may include m′ inlet ports and n×p outlet ports for dynamically redirecting composite signals from the second stage to the first stage.

In addition, in order to perform conversions between bands and/or wavelengths, the second stage may include at least one modulated light source of tuneable wavelength connected to an inlet branch of one of the wavelength multiplexer means.

The second matrix may be optical or electrical. If the second matrix is electrical, the second stage includes optical to electrical converters connected to the direction inlet ports of the second matrix and electrical to optical converters connected to the direction outlet ports of the second matrix.

Preferably, the cross-connector may include a third stage for switching fiber-dedicated digital optical signals, each fiber-dedicated signal comprising digital optical signals in a plurality of bands transported by a single optical fiber.

The invention naturally applies to a switching node including a cross-connector as described above.

The characteristics and objects of the present invention appear from the detailed description given purely with reference to the accompanying figure which is given by way of non-limiting illustration.

The sole figure shows a preferred embodiment of the invention comprising an optical cross-connector 1000 for digital optical signals, each in the form of a carrier wave that is modulated in amplitude, for example.

The multi-granular architecture optical cross-connector 1000 comprises:
a first switching stage 100 for switching composite digital optical signals, each composite signal being made up of a plurality of digital optical signals in a given wavelength band;
a second switching stage 200 for switching digital optical signals by wavelength; and
a third switching stage 300 for switching fiber-dedicated digital optical signals, each fiber-dedicated signal comprising digital optical signals of a plurality of bands transported by a single optical fiber.

The first stage 100 comprises:
four independent optical switching sub-matrices 1 to 4 disposed in parallel, each being dedicated to a distinct wavelength band and each comprising two direction inlet ports 1a to 4b, two direction outlet ports 1′a to 4′b, two redirection inlet ports 11 to 42, and two outlet redirection ports 11′ to 42′;
two wavelength band demultiplexer means 10, 20, each means 10, 20 being suitable for separating composite signals into their distinct wavelength bands and being provided with four outlet ports corresponding to the total number of wavelength bands processed by the cross-connector 1000, the outlet ports of each means 10, 20 being connected to four respective direction inlet ports 1a to 4a, 1b to 4b of the distinct sub-matrices 1 to 4; and
two wavelength band multiplexer means 10′, 20′, each of the means 10′, 20′ being suitable for combining distinct composite signals and being provided with four inlet ports connected to four respective direction outlet ports 1′a to 4′a, 1′b to 4′b of the distinct sub-matrices 1 to 4.

The second stage 200 comprises:
a wavelength optical switching matrix referred to as a “second” matrix 5 having thirty-two inlet and outlet direction ports, four add ports 51 to 54 for adding digital optical signals, and four drop ports 51′ to 54′ for dropping digital optical signals;
four cyclical wavelength demultiplexer means 61 to 64′, e.g. of the waveguide array type, each means having four outlet branches connected to distinct direction inlet ports of the second matrix; and
four cyclical wavelength multiplexer means 61′ to 64′, e.g. of the waveguide type, each of said means comprising four inlet branches connected to distinct direction outlet ports of the second matrix.

In order to redirect composite signals dynamically from the first stage 100 to the second stage 200, the cross-connector 1000 includes an optical concentrator comprising:
eight inlet ports 71 to 78 connected to the eight redirection outlet ports 11′ to 42′; and
four outlet ports 71′ to 74′ respectively connected to the four cyclical demultiplexer means 61 to 64.

The concentrator 7 also has four drop ports 7a to 7d for dropping composite signals, e.g. those for sending to a local network (not shown) connected to the communications node (not shown) containing the cross-connector 100.

In order to redirect composite signals dynamically from the second stage 200 to the first stage 100, the cross-connector 1000 includes an optical deconcentrator 8 comprising:
four inlet ports 81 to 84 connected to the four cyclical demultiplexer means 61′ to 64′; and
eight outlet ports 81′ to 84′ respectively connected to the eight redirection inlet ports 11 to 42.

The deconcentrator 8 also has four add ports 8a to 8d for adding composite signals, e.g. coming from a local network (not shown) connected to the switching node (not shown) containing the cross-connector 1000.

Finally, the third stage 300 has a switching matrix 9 having two add ports 91, 92 for adding fiber-dedicated signals connected to the wavelength band multiplexer means 10′, 20′ respectively via link optical fibers 30′, 40′, and two fiber-dedicated signal drop ports 91′, 92′ connected to the wavelength band demultiplexer means 10, 20 by link optical fibers 30, 40.

The direction inlet and outlet ports of the matrix 9 and the inlet and outlet optical fibers are not shown in order to simplify the drawing.

An example of how the cross-connector 1000 operates is described below.

Two fiber-dedicated signals Fa, Fb comprising the same four wavelength bands B1a to B4a, B1b to B4b are demultiplexed by wavelength band by the means 10, 20 in order to separate four composite signals that are to be directed by distinct sub-matrices 1 to 4. The composite signals are represented in the figure by reference to their bands.

The composite signal B1a is delivered by the redirection port 11′ to the optical concentrator 7 which directs it to the cyclical wavelength demultiplexer means 64 to separate the four digital optical signals s1a to s4a to distinct carrier wavelengths. The digital signals s1a to s4a are directed to a user of a local network (not shown) via the drop ports 51′, 52′. A digital optical signal s1m having the same carrier wavelength as the digital signal s1a is injected into the matrix 5 via the add port 51. Similarly, a digital optical signal s2m having the same carrier wavelength as the digital signal s2a is injected into the matrix via the add port 52. These injected signals s1m, s2m are combined with the signals s3, s4 by the means 64′ to form a composite signal B1m which passes successively through the deconcentrator 8 and the sub-matrix 1 prior to reaching the wavelength band multiplexer means 10′.

The composite signal B2b is delivered by the redirection port 21′ to the optical concentrator 7 which supplies it to a local network via the drop port 7d. In parallel, a composite signal B2x having the same wavelength band as the signal B2b is injected via the add port 8a into the deconcentrator 8 and then passes through the sub-matrix 2 dedicated to said band prior to reaching the wavelength band multiplex means 20′.

Similarly, the composite signal B3a is delivered by the redirection port 32′ to the optical concentrator 7 which supplies it to a local network via the drop port 7b.

Finally, the composite signals B2a, B4a, B1b, B3b, and B4b are directed by the sub-matrix dedicated to their respective bands and reach one of the wavelength band multiplexer means 10′ or 20′.

Two fiber-dedicated signals F′a, F′b are formed by the wavelength band multiplexer means 10, 20.

In a first variant of this embodiment (not shown), the cross-connector does not have a third stage, so the transmission optical fibers are connected directly to the wavelength band demultiplexer means and to the wavelength multiplexer means.

In a second variant of this embodiment (not shown), the four cyclical wavelength band demultiplexer means can be replaced by four wavelength demultiplexer means dedicated respectively to demultiplexing distinct bands plus a cyclical wavelength demultiplexer means associated with four new inlet ports to the second matrix. An analogous replacement can also be implemented for the four cyclical wavelength multiplexer means.

Naturally, the invention is not limited to the embodiment described above.

The matrix of the second stage may equally well be an electrical matrix, in which case it is disposed between sixteen optical to electrical converters connected in parallel (on its inlet side) and sixteen electrical to optical converters connected in parallel (on its outlet side).

When it is necessary to convert wavelengths, one or more inlet branches of one or more wavelength multiplexers may be connected to modulated light sources of tunable carrier wavelengths.

The number of add and drop ports in the second matrix, the number of link fibers, the number of wavelengths per band, and the number of bands are given merely as indications.

In the second matrix, the number of direction outlet ports may be greater than the number of direction inlet ports.

The numbers of outlet ports from the concentrator and from the deconcentrator are selected as a function of traffic fluctuations and of mean traffic levels.

Finally, any means may be replaced by equivalent means without going beyond the ambit of the invention.

1. An optical cross-connector (1000) of multi-granular architecture, the cross-connector comprising:
a first switching stage (100) for switching composite digital optical signals, each composite signal being made up of a plurality of digital optical signals in a given wavelength band, the stage comprising:
a first optical switching matrix (1 to 4) having direction inlet ports (1a to 4b) and direction outlet ports (1′a to 4′b), and having redirection inlet ports (11 to 42) and redirection outlet ports (11′ to 42′);
a number p greater than or equal to 2 of wavelength band demultiplexer means (10, 20), each being connected to a distinct one of said direction inlet ports; and
p wavelength band multiplexer means (10′, 20′), each connected to a distinct one of said direction outlet ports;
a second switching stage (200) for switching digital optical signals, the stage comprising:
a second switching matrix (5) having direction inlet ports and direction outlet ports;
a set of wavelength demultiplexer means (61 to 64), each of said means being connected to distinct direction inlet ports of the second matrix; and
a set of wavelength multiplexer means (61′ to 64′), each of said means being connected to distinct ones of said direction outlet ports of said second matrix;
said redirection outlet ports of the first matrix being coupled with said direction inlet ports of the second matrix via said set of wavelength demultiplexer means in order to obtain dynamic redirection of composite signals from the first stage to the second stage;
the cross-connector being characterized in that the first optical matrix is made up of a series of independent optical switching sub-matrices (1 to 4) disposed in parallel;
and in that the number of redirection outlet ports from the first matrix is greater than the number of wavelength demultiplexer means, the cross-connector having an optical concentrator (7) with more inlet ports (71 to 78) connected to said redirection outlet ports of the first matrix than outlet ports (71′ to 74′) connected to said wavelength demultiplexer means.

2. A cross-connector (1000) according to claim 1, characterized in that said set of wavelength demultiplexer means (61 to 64) comprise at least one cyclical wavelength demultiplexer means (61 to 64), preferably selected from optical deinterlacers and waveguide arrays.

3. A cross-connector (1000) according to claim 1, characterized in that the optical concentrator (7) includes at least one drop port (7a to 7d) for dropping composite signals, in particular those destined for a local network connected to said cross-connector.

4. A cross-connector (1000) according to claim 1, characterized in that said p wavelength band demultiplexer means (10, 20) are provided with n outlet ports where n is greater than or equal to 2, and corresponds to the total number of wavelength bands processed in said cross-connector, and in that said series of sub-matrices comprises n sub-matrices (1 to 4) each dedicated to a distinct wavelength band, having p redirection inlet and outlet ports and q direction inlet and outlet ports.

5. A cross-connector (1000) according to claim 4, characterized in that, said set of wavelength demultiplexer means comprises a number m less than n×p of cyclical wavelength demultiplexer means (61 to 64), and in that said concentrator (7) comprises n×p inlet ports (71 to 78) and m outlet ports (71′ to 74′) for dynamically redirecting composite signals from the first stage (100) to the second stage (200).

6. A cross-connector (1000) according to claim 1, characterized in that the number of direction inlet ports (11 to 42) of the first matrix (1 to 4) is greater than the number of wavelength multiplexer means (61′ to 64′), and in that the cross-connector includes an optical deconcentrator (8) having more outlet ports (81′ to 88′) connected to said redirection inlet ports of the first matrix than inlet ports (81 to 84) connected to said wavelength multiplexer means in order to obtain dynamic redirection of composite signals from the second stage (200) to the first stage (100).

7. A cross-connector (1000) according to claim 6, characterized in that the optical deconcentrator (8) includes at least one add port (8a to 8d) for adding composite signals.

8. A cross-connector (1000) according to claim 6, characterized in that said set of wavelength multiplexer means comprises at least one cyclical wavelength multiplexer means (61′ to 64′), said means preferably being selected from optical interlacers and waveguide arrays.

9. A cross-connector (1000) according to claim 6, characterized in that said p wavelength band multiplexer means (10, 20) are provided with n inlet ports, where n is greater than or equal to 2 and corresponds to the total number of wavelength bands processed in said cross-connector, and in that said series of sub-matrices comprises n sub-matrices (1 to 4) each being dedicated to a distinct wavelength band, comprising p inlet and outlet redirection ports and q inlet and outlet direction ports.

10. A cross-connector (1000) according to claim 9, characterized in that said set of wavelength multiplexer means comprises a number m′ less than n×p of cyclical wavelength multiplexer means (61′ to 64′), and said deconcentrator (8) comprises m′ inlet ports (81 to 84) and n×p outlet ports (81′ to 88′) for dynamically redirecting composite signals from the second stage (200) to the first stage (100).

11. A cross-connector (1000) according to claim 1, characterized in that the second stage includes at least one modulated light source that is suitable in wavelength connected to an inlet branch of one of the wavelength multiplexer means.

12. A cross-connector (1000) according to claim 1, characterized in that the second matrix (5) is an optical matrix.

13. A cross-connector (1000) according to claim 1, characterized in that the second matrix is an electrical matrix and in that the second stage includes optical to electrical converters connected to the direction inlet ports of the second matrix, and electrical to optical converters connected to the direction outlet ports of the second matrix.

14. A cross-connector (1000) according to claim 1, characterized in that it includes a third switching stage (300) for switching fiber-dedicated digital optical signals, each fiber-dedicated signal comprising digital signals in a plurality of bands conveyed by a single optical fiber.

15. A communications node including a cross-connector (1000) according to claim 1.
